(19) United States
(12) Patent Application Publication
(10) Pub. No.: US 2007/0022366 A1
(43) Pub. Date: Jan. 25, 2007

(54) Methods and apparatus for providing web site creation services

(76) Inventor: Kirill Novitchenko, San Francisco, CA (US)

Correspondence Address: LAW OFFICE OF JAMES TROSINO, 92 NATOMA STREET, SUITE 211, SAN FRANCISCO, CA, 94105, US

(21) Appl. No.: 11/158,825

(22) Filed: Jun. 22, 2005

(51) Int. Cl. G06F 17/00

(52) U.S. Cl. 715/500

(57) ABSTRACT

Methods and apparatus are provided for providing web site creation services for end users. A packaged product including an access code, such as an alphanumeric serial number or other similar code, is provided for distribution to an end user. After the end user provides the access code to a web site creation system, the web site creation system verifies the validity of the received access code. If the access code is valid, the web site creation system creates a web site for the end user.

### BACKGROUND

In the last decade, Internet use has grown at a phenomenal rate. Indeed, whereas Internet use was previously the province of scientists, engineers and computer programmers, the Internet is now used by almost everyone with computer access. As a result, the Internet now offers a great range of possibilities for consumers and businesses. Indeed, an online user may conduct research, plan a vacation, read the news, purchase goods, transfer money and perform numerous other tasks, all without ever leaving home.

Although a large number of people now use the Internet, only a small percentage of Internet users actually create their own web site. There are many reasons for this phenomenon. Some users believe that costs associated with establishing, installing, hosting, and maintaining a web site are prohibitive, and thus such users never consider creating a web site. Other users, in contrast, have considered creating their own web site, but have found the process, which often involves contacting several different vendors, and requires some technical knowledge, a bit overwhelming. Still other users who are less familiar with the Internet do not know the steps that are required to create a web site, do not know where to look for a solution, or assume that the process for establishing a web site is so complex that it is not worth the effort.

For users who nevertheless persist in the effort to create a web site, the tools and services available for creating such sites are often too complicated, too limited, or too expensive for many potential users. For example, a user may purchase a commercial software package, such as Dreamweaver by Macromedia, Inc., or FrontPage by Microsoft Corporation, to create a basic brochure-like site. Web sites created using such software, however, typically are static, lack powerful tools and features, and have an amateur look and feel. Because a considerable amount of time is typically required to create a web site using such software, many users abandon their effort without ever completing or publishing their site.

As an alternative to such self-made web sites, many Internet portals that serve a particular industry allow users to create co-branded web sites. For example, many wedding industry web sites (e.g., www.weddingchannel.com) allow users to create co-branded, wedding-themed web sites. Although this option provides a user with a relatively fast and easy way to create a web site, such sites have only the most basic features, and limit user's ability to personalize and customize the site. Indeed, many users find the co-branding requirement of such sites to be tacky and undesirable.

At the other end of the spectrum, a user may order a custom web site from a professional web development company. Such sites may be fully customized, include a custom user interface and provide powerful features. However, for many users, the time required to interview and select a web developer, meet with the developer to provide detailed site requirements, review drafts and then finalize the development, are simply impractical. In addition, the cost of a custom web development project may range from several hundred to several hundred thousand dollars, which is too expensive for many potential users.

In view of the foregoing, it would be desirable to provide methods and apparatus that enable end users to quickly and conveniently create web sites.

It further would be desirable to provide methods and apparatus that enable end users to create web sites at relatively low cost.

It also would be desirable to provide methods and apparatus that enable end users to create web sites without having to contact multiple vendors.

It additionally would be desirable to provide methods and apparatus that make web site creation tools and services more accessible for end users.

It further would be desirable to provide methods and apparatus the enable end users to create web sites that include powerful features.

### SUMMARY

This invention provides methods and apparatus for providing web site creation services for end users. In particular, in a first exemplary embodiment of this invention, a packaged product is provided for distribution to an end user. The packaged product includes an access code, such as an alphanumeric serial number or other similar code. The end user provides the access code to a web site creation system, which verifies the validity of the received access code. If the access code is valid, the web site creation system creates a web site for the end user.

In an alternative embodiment of this invention, a plurality of packaged products are provided for distribution to an end user, with each packaged product associated with a specific type of web site. The packaged products each include an access code, such as an alphanumeric serial number or other similar code uniquely associated with the packaged product. The end user provides the access code to a web site creation system, which verifies the validity of the received access code, and determines the web site type associated with the packaged product. If the access code is valid, the web site creation system creates the specific type of web site for the end user.

Exemplary systems in accordance with this invention include a distribution network and a web site creation system. The distribution network is be used to distribute a plurality of packaged products to end users, with each packaged product associated with a specific type of web site. The packaged products each include an access code, such as an alphanumeric serial number or other similar code uniquely associated with the packaged product. The web site creation system is adapted to receive an access code from an end user, verify the validity of the received access code, determine the specific type of web site associated with the packaged product and create the determined specific type of web site for the end user.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a block diagram of an exemplary web site creation system in accordance with this invention;

FIGS. 2A-2D are diagrams of exemplary packaged products in accordance with this invention;

FIG. 3 is a diagram of an exemplary web site creation process in accordance with this invention;

FIG. 4 is a diagram of an exemplary access code list in accordance with this invention; and

FIG. 5 is a diagram of an exemplary web site type list in accordance with this invention.

### DETAILED DESCRIPTION

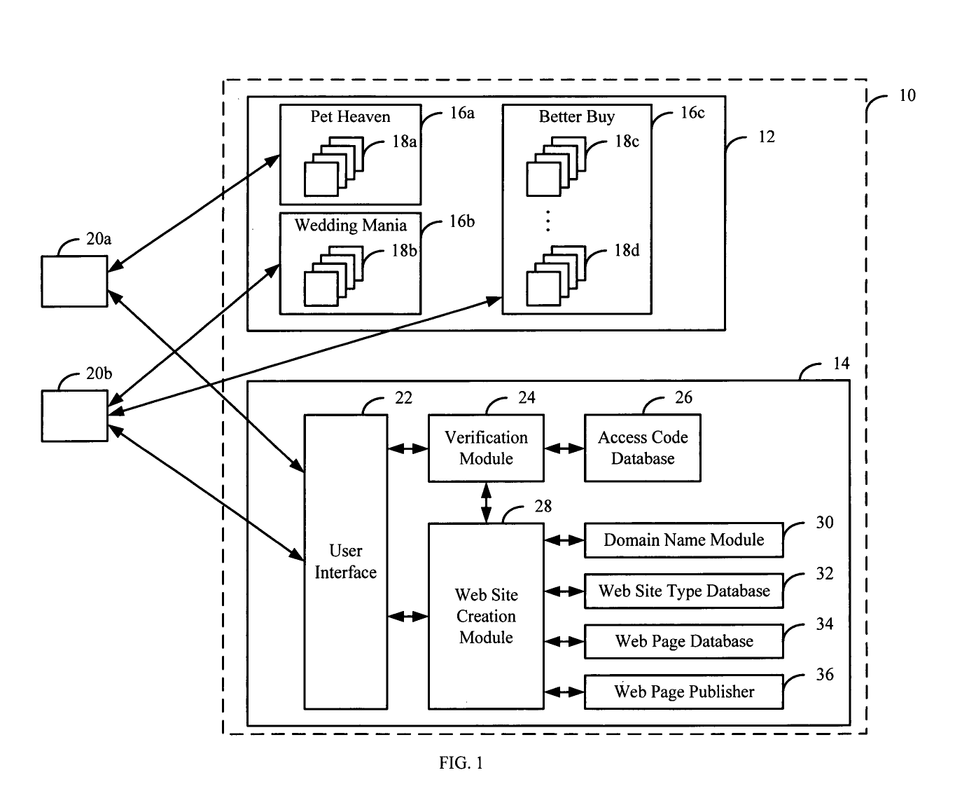

Referring to FIG. 1, a first exemplary system for providing web site creation services in accordance with this invention is described. In particular, exemplary system 10 includes a distribution network 12 and a web site creation system 14. Distribution network 12 includes one or more distributors 16, each of which may distribute packaged products 18 to end users 20. Distributors 16 may include retail distributors, wholesale distributors, corporations, organizations, or other similar distributors. Exemplary retail distributors may include computer stores, electronics stores, greeting card stores, music stores, stationery stores, office supply stores, wedding salons, pet stores, beauty supply stores, travel agencies, gas stations, auto parts supply stores, banks, clothing stores, department stores, hardware stores, baby stores, convenience stores, restaurants, fast food stores, warehouse clubs, discount stores, drug stores, and other similar retail distributors. For example, distributor 16a may be a pet store, distributor 16b may be a wedding boutique, and distributor 16c may be an electronics superstore.

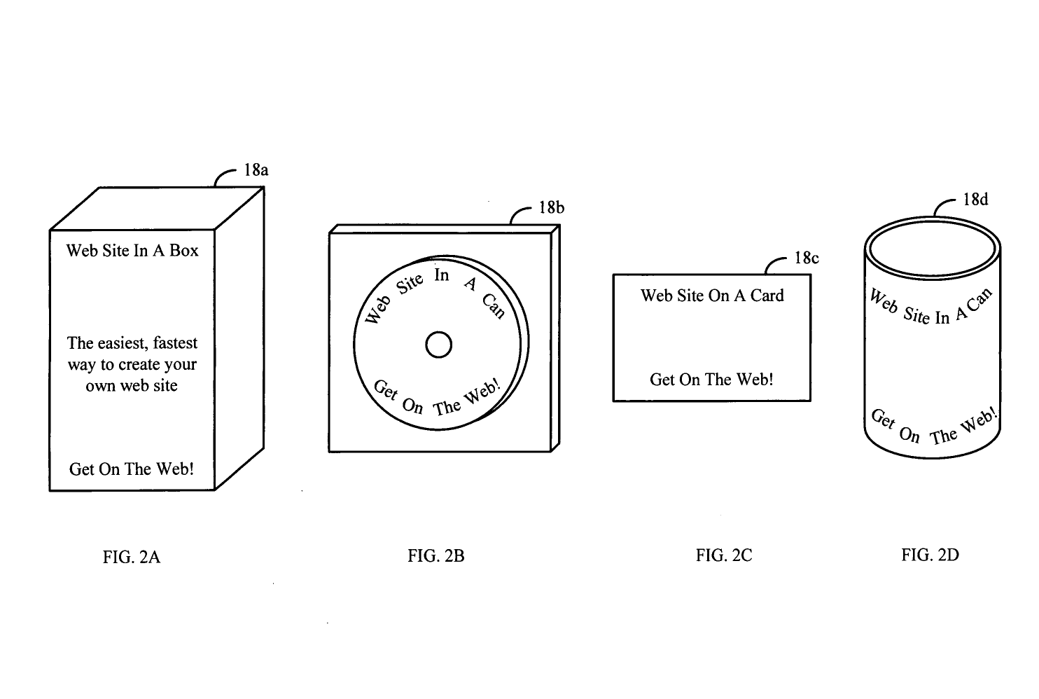

Packaged products 18 may be any packaged products that may be acquired by end users 20 for creating web sites in accordance with this invention. For example, as shown in FIG. 2A-2D, packaged products 18 may be boxed products 18a, jewel cases 18b, electronic gift cards 18c, cans 18d, or other similar packaged products or combination of such packaged products. Each packaged product 18 may include an access code, serial number or other similar identifying information (collectively referred to hereinafter as “access codes”) uniquely associated with the packaged product. Access codes may be alphanumeric codes or other similar codes, and may be printed on or stored electronically in the packaged product 18. For example, an access code may be printed on a paper or cardboard insert included in or comprising the packaged product 18. Alternatively, the access code may be stored on storage media, such as a floppy disk, optical disk, zip disk, flash memory device, or other similar storage media included in or comprising the packaged product 18.

As described in more detail below, end users 20 may acquire packaged products 18 to create web sites, such as Internet and intranet web sites. In particular, each packaged product 18 may be used to create an associated specific type of web site. Exemplary web site types include wedding web sites, baby web sites, vacation web sites, family reunion web sites, pet web sites, photography web sites, professional services web sites, commercial web sites, real estate web sites or other similar web site types. Thus, packaged products 18a, 18b, 18c and 18d may be used to create pet web sites, wedding web sites, family reunion web sites and e-commerce web sites, respectively.

Referring again to FIG. 1, end users 20 may acquire packaged products 18 from one or more of distributors 16. For example, end user 20a may acquire a boxed product 18a from a pet store 16a for creating a pet web site. Similarly, end user 20b may acquire a jewel case 18b from a bridal salon 16b for creating a wedding web site, and may acquire a can 18d from an electronics superstore 16c for creating an e-commerce web site. Persons of ordinary skill in the art will understand that distributors 16 may stock one or more types of packaged products 18. Further, the packaged products 18 stocked by a particular distributor may be for a specific type of web site (e.g., pet, wedding, etc.) associated with the distributor's business, or may be wholly unrelated to the distributor's business. Thus, a pet store may stock packaged products 18a solely for creating pet web sites, or may stock web site packaged products 18b, 18c that may be used for creating other types of web sites. In addition, persons of ordinary skill in the art will understand that distributors 16 may sell, loan, lease, freely distribute or otherwise distribute packaged products 18.

After an end user 20 acquires a packaged product 18 from a distributor 16, the end user then communicates with web site creation system 14 to create a web site. Exemplary web site creation system 14 includes a user interface 22, verification module 24, access code database 26, web site creation module 28, domain name module 30, web site type database 32, web page database 34 and web page publisher 36. Persons of ordinary skill in the art will understand that web site creation systems 14 in accordance with this invention may include more than or less than the various components illustrated in FIG. 1.

In addition, persons of ordinary skill in the art will understand that the various components of web site creation system 14 may be at a single location, or may be distributed over multiple locations. For example, web site creation system 14 may be implemented on a single computer, such as a personal computer, laptop computer, server, or other similar computer processing device. Alternatively, web site creation system 14 may be implemented on multiple computer processing devices or combinations of such devices. In addition, persons of ordinary skill in the art will understand that the various components of web site creation system 14 may be owned or operated by a single entity, or may be owned or operated by multiple entities.

User interface 22 may be a web interface, telephone interface, or other similar user interface for communicating with end users 20. For example, user interface 22 may include one or more web interfaces, with each web interface having an associated web address for creating a particular web site type. Thus, one such web interface may have an address “www.mypet.net” for creating pet web sites, whereas another such web interface may have an address “www.webwedding.net” for creating wedding web sites. Each packaged product 18 may include the web address associated with corresponding web site type. Thus, pet web site packaged products 18 may include the pet web address, whereas wedding web site packaged products 18 may include the wedding web address. Alternatively, user interface 22 may include a web interface having a single web address also may be used to create any of a plurality of different types of web sites. For such a web interface, the access code or some other similar parameter may be used to determine the specific type of web site to be created.

User interface 22 also may include one or more telephone interfaces, with each telephone interface having an associated telephone number for creating a particular web site type. Thus, one such telephone interface may have a phone number “888-PET-SITE” for creating pet web sites, whereas another such telephone interface may have a phone number “800-WED-SITE” for creating wedding web sites. Each packaged product 18 may include the phone number associated with corresponding web site type. Thus, pet web site packaged products 18 may include the pet phone number, whereas wedding web site packaged products 18 may include the wedding phone number. Alternatively, user interface 22 may include a telephone interface having a single phone number for creating any of a plurality of different types of web sites. For such a web interface, the access code or some other similar parameter may be used to determine the specific type of web site to be created. Other similar user interfaces also may be provided. For simplicity, in the remaining discussion, user interface 22 will be assumed to include a web interface having a single web address for communicating with end users 20.

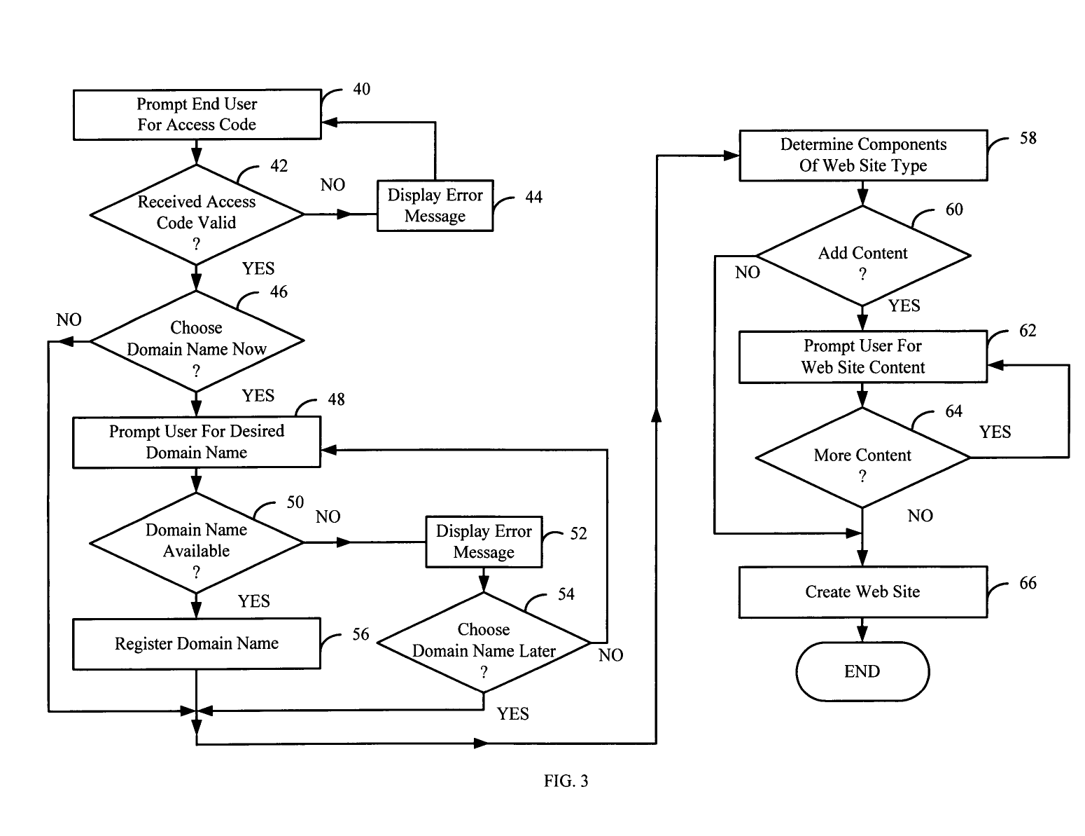

Referring now to FIGS. 1 and 3, an exemplary process is described for creating web pages for end users 20. In particular, at step 40, user interface 22 prompts end user 20 to enter the access code included in packaged product 18. For example, the web interface may prompt the user to enter the access code using a keyboard, mouse, pointing device, or other similar user interface tool for entering information on a web page. Next, at step 42, web site creation system 14 determines if the received access code is valid. In particular, access code database 26 may include a list of valid access codes included in packaged products 18. User interface 22 may provide the received access code to verification module 24, which then compares the received access code to an access code list in access code database 26.

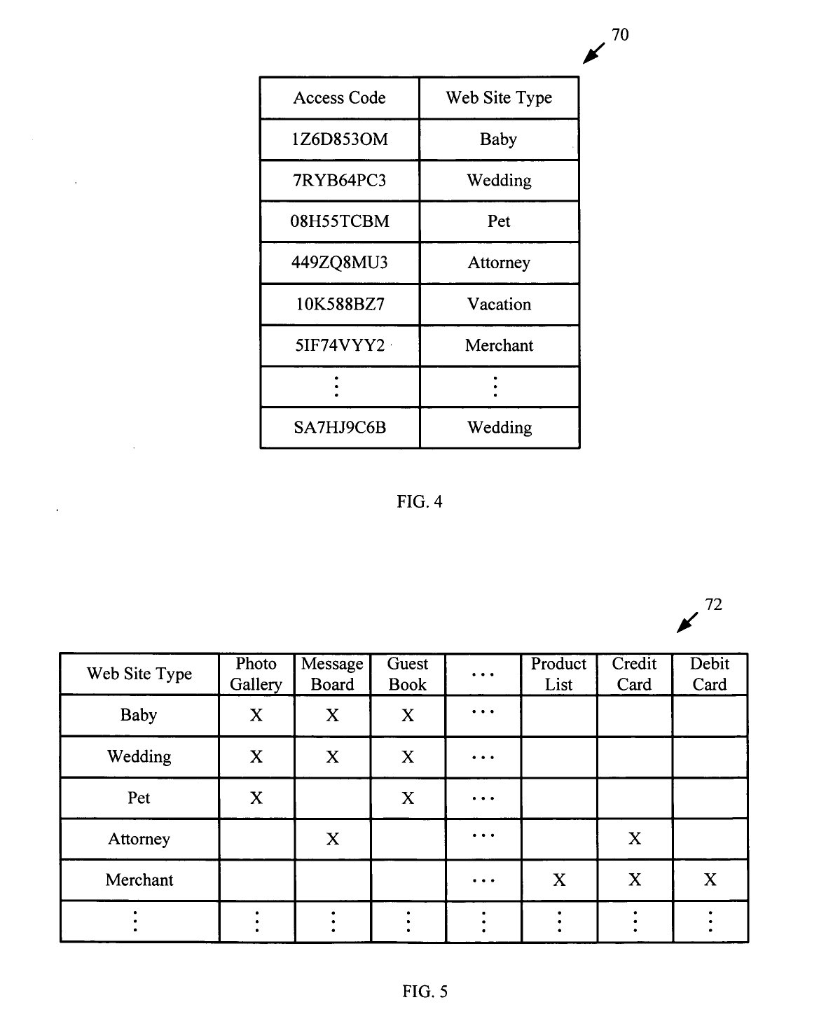

Referring now to FIG. 4, an exemplary access code list is described. In particular, exemplary access code list 70 may include a list of valid access codes. In the illustrated example, access code list 70 includes access codes that are each nine-digit alpha-numeric codes. Persons of ordinary skill in the art will understand that access codes may include more or less than nine digits, and that all access codes may not include the same number of digits. In addition, for systems in which the web site type associated with each packaged product 18 may not be determined from the web address or phone number used by the end user 20, access code list 70 also may include a web site type associated with each access code. Thus, for example, access code “IZ6D853OM” may be associated with a “Baby” web site type, access code “449ZQ8MU3” may be associated with an “Attorney” web site type, and access code “10K588BZ7” may be associated with a “Vacation” web site type.

Referring again to FIGS. 1 and 3, if the access code provided by end user 20 is invalid, at step 44 an error message may be displayed, and the user may be prompted at step 40 to re-enter the access code. If the received access code is valid, verification module 24 provides the web site type associated with the packaged product 18 to web site creation module 28. At step 46, web site creation module 28 determines whether end user 20 wants to immediately choose a domain name for their web site, or wait until later to select a domain name. If end user 20 wants to immediately select a domain name, at step 48, web site creation module 28 prompts the user via user interface 22 to provide a desired domain name for the user's web site. For example, the user may request “www.mypetgoat.com,” or any other desired domain name.

At step 50, web site creation module 28 determines if the user's desired domain name is available. For example, web site creation module 28 may communicate with a domain name registrar (not shown) to determine if the end user's desired domain name is available for registration. If the desired domain name is unavailable, at step 52 an error message may be displayed, and end user 20 may be asked at step 54 whether the user wants to try again, or select a domain name at a later time. If end user 20 wants to try again, at step 48 the end user will be prompted to enter an alternative domain name. In this regard, web site creation module 28 may suggest variations of the user's initially requested domain name. Once the user has entered a desired domain name that is available for registration, at step 56 web site creation module 28 registers the desired domain name. For example, web site creation module 28 may register the desired domain name with a domain name registry service.

Alternatively, if at steps 46 or 54 end user 20 decides to wait until later to select a domain name, web site creation module 28 may assign a unique uniform resource locator (“URL”) that may be used to identify the user's web site. For example, if end user “Joe Smith” wants to create a web site, but does not yet want to select a domain name for the site, web site creation module 28 may assign the URL “www.mypet.net/sites/joesmith/” for the web site for this end user. At a later time, Joe Smith may communicate with web site creation module 28 to select a domain name for his site.

Next, at step 58, web site creation module 28 determines the components included in the type of web site associated with the received access code. In particular, web site type database 32 may include a list of web site types and the components included in each web site type. Referring now to FIG.5, an exemplary web site type list is described. In particular, exemplary web site type list 72 indicates that a Baby web site includes a photo gallery, a message board and a guest book, whereas a Merchant web site includes a product list, a credit card processing module and a debit card processing module. Persons of ordinary skill in the art will understand that web site type list 72 may include components other than the examples shown in FIG. 5, and that the number of components maybe more or less than the number shown in the figure.

Referring again to FIGS. 1 and 3, at step 60, web site creation module 28 asks whether end user 20 wants to add content to their web site. Exemplary content includes text, images, graphics, documents, hyperlinks and other similar content. If end user 20 wants to add content, at step 62, web site creation module 28 prompts the end user to provide content that may be included in the web site. At step 64, web site creation module 28 determines if end user 20 wants to add any additional content to the web site. If so, at step 62, web site creation module 28 prompts end user 20 to provide the additional content.

Alternatively, if at step 60 end user 20 does not want to add any content to the web site, the process proceeds to step 66, at which point web site creation module 28 creates the desired web site using the components determined at step 54 and any content provided by end user 20 at step 62. In particular, web site creation module 28 may create one or more web pages to be included in the end user's web site. During the web pages creation process, web site creation module 28 may store the web pages in web page database 34. After creating the web pages, web site creation module 28 may display the web pages for approval and/or revision by end user 20. Once the end user has accepted the format of the web pages, web site creation module 28 may provide the web pages to web page publisher 36, which may then submit the web pages to a web hosting server (not shown) that will host the end user's web site.

The foregoing merely illustrates the principles of this invention, and various modifications can be made by persons of ordinary skill in the art without departing from the scope and spirit of this invention. For example, persons of ordinary skill in the art will understand that methods and apparatus in accordance with this invention may permit a user to optionally exclude one or more modules from their web site. Thus, for example, if a Baby web site typically includes a photo gallery, message board and guest book, an end user 20 may optionally elect to exclude one or more of these modules from their web site.

Additionally, methods and apparatus in accordance with this invention may permit a user to optionally include one or more additional modules in their web site. For example, if an Attorney web site typically includes a message board and credit card processing module, an end user 20 may optionally elect to include one or more additional modules (e.g., a photo gallery) in their web site. In this regard, methods and apparatus in accordance with this invention may allow an end user 20 to purchase additional modules for a fee. These and other modifications are all included within the scope of this invention.

1. A method for providing web site creation services, the method comprising:
providing a packaged product for distribution to an end user, the packaged product comprising an access code;
receiving the access code from the end user;
verifying the validity of the received access code; and
creating the web site for the end user.

2. The method of claim 1, wherein the packaged product comprises a boxed product.

3. The method of claim 1, wherein the packaged product comprises an optical disk.

4. The method of claim 1, wherein the packaged product comprises a web address.

5. The method of claim 1, further comprising selling the packaged product to the end user.

6. The method of claim 1, wherein providing comprises providing the packaged product to a retail distributor for resale to the end user.

7. A method for providing web site creation services, the method comprising:
providing a plurality of packaged products for distribution to an end user, each packaged product associated with a specific type of web site and comprising an access code;
receiving an access code from an end user;
verifying the validity of the received access code;
determining the specific type of web site associated with the end user's packaged product; and
creating the specific type of web site for the end user.

8. The method of claim 7, wherein the specific types of web sites comprise any of a wedding web site, a baby web site, a vacation web site, a family reunion web site, a pet web site, a photography web site, a professional services web site, a commercial web site, and a real estate web site.

9. The method of claim 7, wherein the packaged products comprise boxed products.

10. The method of claim 7, wherein the packaged products comprise an optical disk.

11. The method of claim 7, wherein the packaged products comprise a web address.

12. The method of claim 7, further comprising selling the packaged products to the end user.

13. The method of claim 7, wherein providing comprises providing the packaged products to a retail distributor for resale to the end user.

14. A system for providing web site creation services, the system comprising:
a distribution network for distributing a plurality of packaged products to end users, each packaged product associated with a specific type of web site and comprising an access code; and
a web site creation system adapted to receive an access code from an end user, verify the validity of the received access code, determine the specific type of web site associated with the end user's packaged product and create the determined specific type of web site for the end user.

15. The system of claim 14, wherein the web creation program comprises software accessed via a web site.

16. The system of claim 14, wherein the distribution network comprises any of a computer store, a pet store, an office supply store, a bridal shop, a travel agent, a real estate agent, a photography store, a camera shop, an electronics store, a discount store, and a department store.

17. The system of claim 14, wherein the specific types of web sites comprise any of a wedding web site, a baby web site, a vacation web site, a family reunion web site, a pet web site, a photography web site, a professional services web site, a commercial web site, and a real estate web site.

18. The system of claim 14, wherein the packaged products comprise boxed products.

19. The system of claim 14, wherein the packaged products comprise an optical disk.

20. The system of claim 15, wherein the packaged products comprise an address of the web creation web site.
